(19) United States
(12) Patent Application Publication
(10) Pub. No.: US 2019/0130492 A1
(43) Pub. Date: May 2, 2019

(54) SYSTEMS AND METHODS FOR DETECTING FRAUDULENT HEALTHCARE CLAIM ACTIVITY

(71) Applicant: FraudScope Inc., Atlanta, GA (US)

(72) Inventors: Musheer Ahmed, Lawrenceville, GA (US); Leandro Damian Gryngarten, Dunwoody, GA (US); Eliezer Hershkovits, Decatur, GA (US); Adam Floyd Hannon, Loganville, GA (US)

(21) Appl. No.: 16/171,861

(22) Filed: Oct. 26, 2018

Related U.S. Application Data
(60) Provisional application No. 62/577,827, filed on Oct. 27, 2017.

(51) Int. Cl. G06Q 40/08; G06Q 10/10; G06Q 10/06

(52) U.S. Cl. CPC G06Q 40/08; G06Q 10/0635; G06Q 10/10

(57) ABSTRACT

A method and system are provided for detecting fraudulent healthcare claim activity. An example system includes an analyzer to receive eligibility data related to an interaction between a service provider and a service recipient, and to generate one or more risk scores based on the eligibility data for a subsequent claim submitted based on the eligibility data, the eligibility data being accessed from at least one of a data stream and a storage component; a translator to interpret the one or more risk scores from the analyzer and to generate a user format representative of the one or more risk scores for the subsequent claim; and an interface component to cause a display of the user format.

### CROSS-REFERENCE TO RELATED APPLICATION

This application claims the benefit of U.S. Provisional Application No. 62/577,827, filed on Oct. 27, 2017, which is incorporated herein by reference in its entirety.

### FIELD

The described embodiments relate to systems and methods for detecting fraudulent healthcare claim activity.

### BACKGROUND

Healthcare fraud causes significant financial loss in the healthcare system. Fraud detection typically begins after a claim is submitted by a service provider and so, there can be delays between when a service is provided, the claim submission and the fraud analysis. The delay, unfortunately, can allow fraudsters to continue their malicious activities for an extended time period.

### SUMMARY

The various embodiments described herein generally relate to methods (and associated systems configured to implement the methods) for detecting fraudulent healthcare claim activity.

In accordance with an embodiment, there is provided a system for detecting fraudulent healthcare claim activity. The system includes: an analyzer to receive eligibility data related to an interaction between a service provider and a service recipient, and to generate one or more risk scores based on the eligibility data for a subsequent claim submitted based on the eligibility data, the eligibility data being accessed from at least one of a data stream and a storage component; a translator to interpret the one or more risk scores from the analyzer and to generate a user format representative of the one or more risk scores for the subsequent claim; and an interface component to cause a display of the user format.

In some embodiments, the analyzer generates the one or more risk scores by applying one or more analytical methods.

In some embodiments, each risk score generated by the analyzer comprises a set of supporting data; and the translator generates the user format with reference to the associated set of supporting data.

In some embodiments, the translator operates to identify a subset of risk scores from the one or more risk scores associated with a risk exposure that exceeds a risk threshold, wherein the risk exposure corresponds to at least one of a value of the risk score and a monetary loss associated with the subsequent claim, and to generate the user format based on the identified subset of risk scores.

In some embodiments, the risk exposure corresponds to a weighted combination of the value of the risk score and the monetary loss associated with the subsequent claim.

In some embodiments, the analyzer operates to generate the one or more risk scores based on one or more of a service provider data related to prior healthcare claim activity of the service provider and a service recipient data related to prior healthcare claim activity of the service recipient.

In some embodiments, the system includes a comparator to generate a comparison of the subsequent claim with a claim provided by an analogous service provider for an analogous service recipient.

In some embodiments, the system includes a case manager to identify from the storage component a set of subsequent claims associated with a risk exposure exceeding a priority threshold.

### BRIEF DESCRIPTION OF THE DRAWINGS

Several embodiments will now be described in detail with reference to the drawings, in which:

FIG. 1 is a block diagram of components interacting with a fraud detection system in accordance with an example embodiment; and

FIG. 2 is a flowchart of an example embodiment of various methods of detecting fraudulent healthcare claim activity.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to methods (and associated systems configured to implement the methods) for detecting fraudulent healthcare claim activity.

Existing fraud detection systems in the healthcare industry begins after healthcare claims are submitted by the service provider. In the United States, the healthcare claims from the service provider are typically submitted in a standard form. The claims data in the claim submission can include information on the diagnosis, procedure performed, an amount charged and a location where the treatment was provided. Unfortunately, as the fraud detection does not take place until after the healthcare claims are submitted, the delay can allow for an extended period of fraudulent activities.

Common fraudulent activities within the healthcare industry include, but are not limited to, upcoding of services, upcoding of items, duplicate claims, unbundling, excessive services, and medically unnecessary services.

Upcoding of services takes place when the service provider submits a healthcare claim with a procedure code that yields a higher payment than a procedure code for the actual service rendered. Similar to upcoding of services, upcoding of items involves the service provider, such as a medical supplier, submitting a claim for a higher cost item than was delivered.

Duplicate claims are when two different claims are submitted when a service was only provided by the service provider once.

Unbundling takes place when the service provider bills for a service in a fragmented fashion when billing the service together would yield a reduced cost.

Excessive services and medically unnecessary services apply to claims that involve services or items that are not needed by the patient or not justified by the patient's medical condition or diagnosis.

The systems and methods described herein operate to detect fraudulent healthcare claim activity by analyzing an eligibility request. When a patient (service recipient) first arrives at a medical facility to receive healthcare, the service provider at the medical facility will verify the patient's healthcare eligibility. The eligibility request includes eligibility data that can be analyzed by the fraud detection system for detecting fraudulent healthcare claim activity.

Eligibility data can include information received by the fraud detection system prior to submitting the healthcare claim, such as, but not limited to, eligibility of the patient for treatment and prior claim submissions of the service provider. The eligibility data can be stored in a standard format, such as Eligibility Benefit Inquiry (EDI) 270/271 format, or another format. The eligibility data can be accessed by the fraud detection system locally or via a network.

The fraud detection system can analyze the eligibility data to generate a risk score for the eligibility request. In some embodiments, the fraud detection system can supplement the analysis of the eligibility data with reference to subsequent and/or related claim data. The fraud detection system can then translate the results of the analysis to a user format that can be easily understood by a user, such as a fraud investigator. The fraud detection system can, in some embodiments, prioritize the results for the user. The fraud detection system can then generate the results for display to a stand-alone platform and/or an interface that is part of a larger platform.

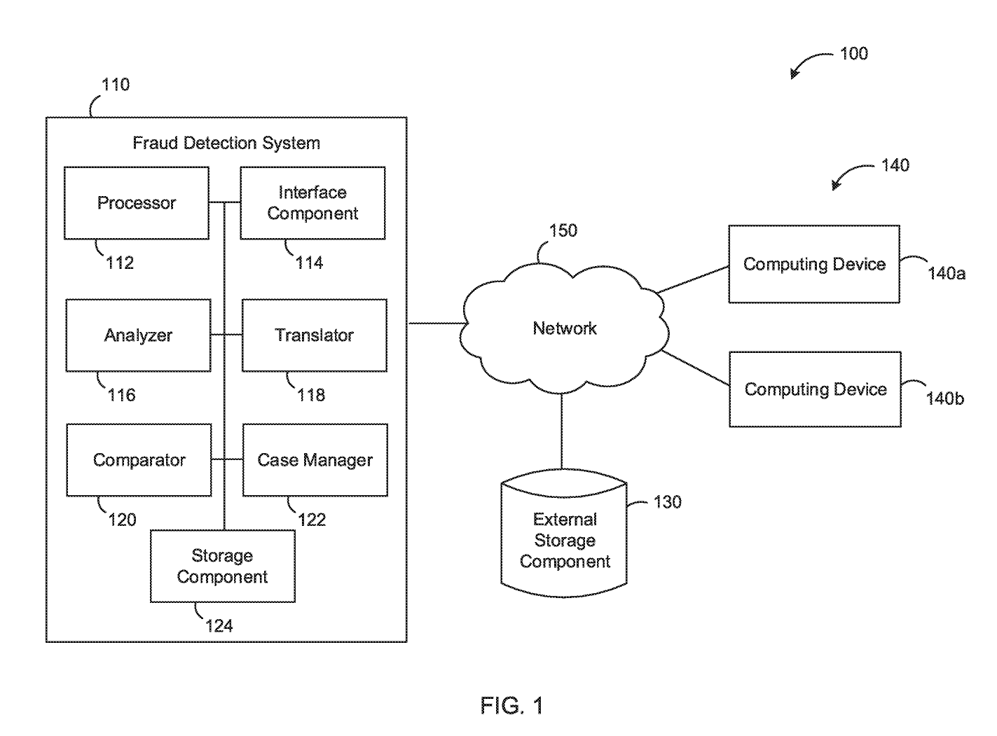

Reference will now be made to FIG. 1, which is a block diagram 100 of components interacting with an example fraud detection system 110.

The fraud detection system 110 is in communication with computing devices 140a, 140b and an external storage component 130 via a network 150. Although two computing devices 140a, 140b are shown, fewer or more computing devices 140 can communicate with the fraud detection system 110.

The fraud detection system 110 includes a processor 112, an interface component 114, an analyzer 116, a translator 118, a comparator 120, a case manager 122 and a storage component 124.

In some embodiments, each of the processor 112, the interface component 114, the analyzer 116, the translator 118, the comparator 120, the case manager 122, and the storage component 124 may be combined into a fewer number of components or may be separated into further components. The processor 112, the interface component 114, the analyzer 116, the translator 118, the comparator 120, the case manager 122, and the storage component 124 may be implemented in software or hardware, or a combination of software and hardware.

The fraud detection system 110 can be provided with any one or more computer servers that may be distributed over a wide geographic area and connected via the network 150.

The processor 112 controls the operation of the fraud detection system 110. The processor 112 may be any suitable processors, controllers or digital signal processors that can provide sufficient processing power depending on the configuration, purposes and requirements of the fraud detection system 110. In some embodiments, the processor 112 can include more than one processor with each processor being configured to perform different dedicated tasks.

The interface component 114 may be any interface that enables the fraud detection system 110 to communicate with other devices and systems. In some embodiments, the interface component 114 can include at least one of a serial port, a parallel port or a USB port. The interface component 114 may also include at least one of an Internet, Local Area Network (LAN), Ethernet, Firewire, modem or digital subscriber line connection. Various combinations of these elements may be incorporated within the interface component 114.

For example, the interface component 114 may receive input from various input devices, such as a mouse, a keyboard, a touch screen, a thumbwheel, a track-pad, a track-ball, a card-reader, voice recognition software and the like depending on the requirements and implementation of the fraud detection system 110.

The storage component 124 can include RAM, ROM, one or more hard drives, one or more flash drives or some other suitable data storage elements such as disk drives, etc. The storage component 124 may include one or more databases (not shown) for storing information relating to, for example, eligibility data, service providers, patients, types of treatments and/or procedures, etc.

The analyzer 116 can be operated to analyze the eligibility request to generate a risk score for that eligibility request and subsequent healthcare claim that is filed based on that eligibility request. The analyzer 116 can, in some embodiments, generate a risk score for the service provider based on the eligibility request. With the risk score, the analyzer 116 can include supporting data for the risk score generated.

Various different methods of generating the risk score can be used, including but not limited to, rule-based systems that describe known or predicted patterns of suspicious behavior, methods of identifying anomalies, comparison with peer values (e.g., Box Plot method), etc. Example rules in a rule-based analysis could include men do not require pregnancy ultrasounds, a reasonable distance between a beneficiary and a service provider, frequency of patient readmission, healthcare service frequency, a total amount of service provider billings, and whether the appropriate medical codes are applied to the services provided. If any of these rules are triggered, that service provider can be flagged as suspicious. In some embodiments, the analyzer 116 can apply multiple analytical methods.

The analyzer 116 can receive data from various data sources for generating the risk score for the eligibility request. An example data source can include eligibility data received within the EDI 270/271 standard. Another example data source can include a real-time claim data stream. Another example data source can include standardized claims information, such as that used by the Accredited Standards Committee (ASC) X12 to describe the care that was provided. An example of such a form is EDI 837. Another example data source can include databases of claims data accessible after payment is paid.

The translator 118 can receive the risk score(s) from the analyzer 116 and can then represent the risk score in a user format. The user format is intended to be easily understood by users of the fraud detection system 110 (e.g., fraud investigators) and to assist with their investigation of the service provider and/or related claims.

The user format can vary with the analytical process, or the number of analytical processes, applied by the analyzer 116. For example, for a rule-based analysis, the translator 118 can provide a user format that includes the resulting risk score along with an identification of the rules, or some of the rules, that were violated. When multiple analytical processes are applied, the translator 118 can select some of the risk scores, and associated supporting data, for display in the user format. For example, the translator 118 can analyze the risk scores and associated supporting data received from the analyzer 116 and only display the top anomalies in the user format. In some embodiments, the translator 118 can select from the risk scores and associated supporting data received from the analyzer 116, the highest cost exposures. In some embodiments, the translator 118 can select from the risk scores and associated supporting data received from the analyzer 116 based on a weighted balance of the abnormal behavior and cost exposure.

The translator 118 can generate different user formats at the claim level and at the service provider level.

The comparator 120 can generate a comparison for each service provider. The comparison can be with a similar service provider, such as type of practice, location, etc. By comparing a service provider with a peer service provider, the comparator 120 can identify typical trends as well as abnormal behavior of the service provider being analyzed.

The case manager 122 can organize the service providers and/or claims for the fraud investigator to maximize the return of savings while minimizing time and resources spent. The case manager 122 can determine, from the results of the analyzer 116, the translator 118 and/or the comparator 120 which of the service provider is associated with the riskiest behaviors and highest cost exposures. By identifying the most costly behaviors, the case manager 122 enables the fraud investigator to limit the time and resources spent on less risky service providers and/or claims.

Each of the computing devices 104a, 104b may be any networked device operable to connect to the network 150. A networked device is a device capable of communicating with other devices through a network such as the network 150. A networked device may couple to the network 150 through a wired or wireless connection.

As noted, these computing devices may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The network 150 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the fraud detection system 110, the external storage component 130 and the computing devices 140.

The external storage component 130 can be similar to the storage component 124 but located remotely from the fraud detection system 110 and accessible via the network 150. For example, the external storage component 130 can include one or more databases for storing information relating to, for example, eligibility data, service providers, patients, types of treatments and/or procedures, etc.

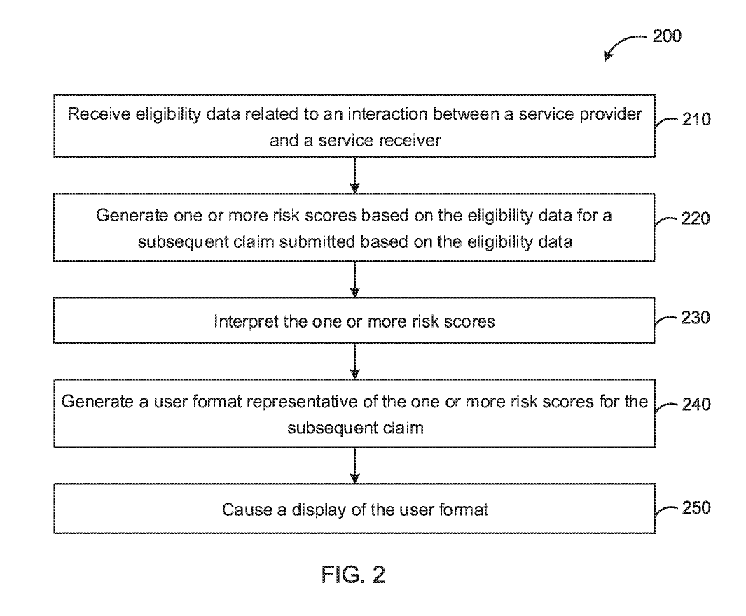

Reference is now made to FIG. 2, which is a flowchart of an example method of detecting fraudulent healthcare claim activity.

At 210, the analyzer 116 receives eligibility data related to an interaction between a service provider and a service recipient, such as a patient. The eligibility data can be accessed from a data stream and/or the storage components 124, 130.

In some embodiments, the analyzer 116 can generate the risk scares based on a service provider data related to prior healthcare claim activity of the service provider and/or a service recipient data related to prior healthcare claim activity of the service recipient.

At 220, the analyzer 116 generates one or more risk scores based on the eligibility data for a subsequent claim submitted based on the eligibility data. The analyzer 116 can generate the one or more risk scores by applying one or more analytical different methods.

Each risk score includes a set of supporting data, as described.

At 230, the translator 118 interprets the one or more risk scores from the analyzer 116.

At 240, the translator 118 generates the user format representative of the one or more risk scores for the subsequent claim. The translator 118 can generate the user format with reference to the set of supporting data associated with the respective risk score.

In some embodiments, the translator 118 can identify a subset of risk scores from the one or more risk scores that are associated with a risk exposure exceeding a risk threshold. The risk threshold represents the minimum risk exposure that warrants investigation by the user of the fraud detection system 110. The risk threshold can be user defined and/or predefined for the fraud detection system 110. The risk threshold can be varied by the user of the fraud detection system 110 or dynamically based on the number of risk scores in the identified subset that exceeds a current risk threshold.

The risk exposure can correspond to a value of the risk score and/or a monetary loss associated with the subsequent claim. For example, the risk exposure can reflect a weighted combination of the value of the risk score and the monetary loss. By determining the risk exposure based on the risk score and the monetary loss, the fraud detection system 110 can identify the claims associated with some of the riskiest and costly healthcare claim activity.

At 250, the interface component 114 is operated by the processor 112 to cause a display of the user format. For example, the processor 112 can operate the interface component 114 to transmit the user format to the computing device 140a for display. In another example, the interface component 114 can include a display and the processor 112 can operate the interface component 114 to display the user format.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1. A system for detecting fraudulent healthcare claim activity, the system comprising:
an analyzer to receive eligibility data related to an interaction between a service provider and a service recipient, and to generate one or more risk scores based on the eligibility data for a subsequent claim submitted based on the eligibility data, the eligibility data being accessed from at least one of a data stream and a storage component;
a translator to interpret the one or more risk scores from the analyzer and to generate a user format representative of the one or more risk scores for the subsequent claim; and
an interface component to cause a display of the user format.

2. The system of claim 1, wherein the analyzer generates the one or more risk scores by applying one or more analytical methods.

3. The system of claim 1, wherein each risk score generated by the analyzer comprises a set of supporting data; and
the translator generates the user format with reference to the associated set of supporting data.

4. The system of claim 1, wherein the translator operates to identify a subset of risk scores from the one or more risk scores associated with a risk exposure that exceeds a risk threshold, wherein the risk exposure corresponds to at least one of a value of the risk score and a monetary loss associated with the subsequent claim, and to generate the user format based on the identified subset of risk scores.

5. The system of claim 4, wherein the risk exposure corresponds to a weighted combination of the value of the risk score and the monetary loss associated with the subsequent claim.

6. The system of claim 1, wherein the analyzer operates to generate the one or more risk scores based on one or more of a service provider data related to prior healthcare claim activity of the service provider and a service recipient data related to prior healthcare claim activity of the service recipient.

7. The system of claim 1, further comprises:
a comparator to generate a comparison of the subsequent claim with a claim provided by an analogous service provider for an analogous service recipient.

8. The system of claim 1, further comprises:
a case manager to identify from the storage component a set of subsequent claims associated with a risk exposure exceeding a priority threshold.

9. A method for detecting fraudulent healthcare claim activity, the method comprising:
receiving, by an analyzer, eligibility data related to an interaction between a service provider and a service recipient, the eligibility data being accessed from at least one of a data stream and a storage component;
generating, by the analyzer, one or more risk scores based on the eligibility data for a subsequent claim submitted based on the eligibility data;
interpreting, by a translator, the one or more risk scores from the analyzer to generate a user format representative of the one or more risk scores for the subsequent claim; and
causing, by an interface component, display of the user format.

10. The method of claim 9, wherein generating the one or more risk scores comprises applying one or more analytical methods.

11. The method of claim 9, wherein each risk score generated by the analyzer comprises a set of supporting data; and
generating the user format comprises generating the user format with reference to the associated set of supporting data.

12. The method of claim 9 comprises:
operating to identify a subset of risk scores from the one or more risk scores associated with a risk exposure that exceeds a risk threshold, wherein the risk exposure corresponds to at least one of a value of the risk score and a monetary loss associated with the subsequent claim, and
generating the user format based on the identified subset of risk scores.

13. The method of claim 12, wherein the risk exposure corresponds to a weighted combination of the value of the risk score and the monetary loss associated with the subsequent claim.

14. The method of claim 9 comprises:
generating the one or more risk scores based on one or more of a service provider data related to prior healthcare claim activity of the service provider and a service recipient data related to prior healthcare claim activity of the service recipient.

15. The method of claim 9, further comprises:
generating a comparison of the subsequent claim with a claim provided by an analogous service provider for an analogous service recipient.

16. The method of claim 9, further comprises:
identifying, by a case manager, from the storage component a set of subsequent claims associated with a risk exposure exceeding a priority threshold.
